(19) United States
(12) Patent Application Publication
(10) Pub. No.: US 2026/0237819 A1
(43) Pub. Date: Aug. 13, 2026

(54) BATTERY MODULE HAVING STRUCTURE ENABLING UNIFORM PRESSURE TO BE APPLIED DURING SWELLING, AND BATTERY PACK AND VEHICLE COMPRISING SAME

(71) Applicant: LG ENERGY SOLUTION, LTD., Seoul (KR)

(72) Inventor: Dong-Wook Kim, Daejeon (KR)

(21) Appl. No.: 19/638,019

(22) Filed: Apr. 2, 2026

Related U.S. Application Data
(63) Continuation of application No. 18/032,336, filed on Feb. 10, 2022.

(30) Foreign Application Priority Data
Feb. 15, 2021 (KR) 10-2021-0020137

(51) Int. Cl. H01M 50/242; H01M 10/04; H01M 50/211; H01M 50/224; H01M 50/249; H01M 50/264; H01M 50/271; H01M 50/291

(52) U.S. Cl. CPC H01M 50/242; H01M 10/0481; H01M 50/211; H01M 50/224; H01M 50/249; H01M 50/264; H01M 50/271; H01M 50/291; H01M 2220/20

(57) ABSTRACT

A battery module including a cell stack including a plurality of battery cells; and a housing including a base plate covering a lower surface of the cell stack, a cover plate covering an upper surface of the cell stack, and a connector connecting the base plate and the cover plate, and accommodating the cell stack. The base plate and the cover plate have a curved shape so that the central region thereof is located closer to the cell stack than the edge regions.

### CROSS-REFERENCE TO RELATED APPLICATIONS

This application is a Continuation of U.S. patent application Ser. No. 18/032,336, filed on Apr. 17, 2023, which is a U.S. national phase of international application No. PCT/KR2022/002052, filed on Feb. 10, 2022, and claims priority to Korean Patent Application No. 10-2021-0020137, filed on Feb. 15, 2021, the disclosures of which are incorporated herein by reference in their entirety as if fully set forth herein.

### TECHNICAL FIELD

The present disclosure relates to a battery module having a structure allowing uniform pressure to be applied when swelling occurs, and a battery pack and a vehicle including the same. More specifically, the present disclosure relates to a battery module including a housing in which a structural change is made to prevent pressure from being concentrated only in the central region of a battery cell when swelling of a battery cell occurs, and a battery pack and a vehicle including the same.

### BACKGROUND

As illustrated in FIG. 1, a conventional battery module includes a cell stack including a plurality of battery cells 100 and a swelling absorbing pad 200, and a housing 300 accommodating the cell stack. In the conventional battery module, an upper plate 300a and a lower plate 300b of the housing 300 have an approximately flat shape.

When the upper plate 300a and the lower plate 300b of the housing 300 have such a flat shape, the upper plate 300a and the lower plate 300b are bent upward and downward, respectively, during swelling of the battery cell 100.

Due to bending of the upper plate 300a and the lower plate 300b, the pressure of the upper plate 300a and the lower plate 300b with respect to the battery cells 100 is relatively low in the central region of the battery cell 100 and is relatively strong toward the edge regions.

Accordingly, as the gas generated in the battery cells 100 is concentrated in the central region of the battery cells 100, the separator constituting the electrode assembly may show wrinkles, and it impedes the movement of electrons, thereby accelerating degradation of the battery cells 100.

In addition, when the pressure is concentrated on the edge regions of the battery cells 100, the expansion amount due to swelling in the central region is excessively large, which may cause tearing in the pouch module housing.

Therefore, there is a need for developing a battery module having a structure in which deviation of the pressure applied to the battery cells due to swelling is resolved and the bending rigidity of the housing improves at a position corresponding to the central region of the battery cells.

### SUMMARY

The present disclosure is designed to solve the problems of the related art, and therefore the present disclosure is directed to providing a battery module housing having a structure in which deviation of the pressure applied to a battery cell due to swelling is resolved and the bending rigidity of the housing is improved at a position corresponding to the central region of the battery cells.

However, technical problems to be solved by the present disclosure are not limited to the above-described problems, and other problems not mentioned herein may be clearly understood by one of ordinary skill in the art from the following description of the present disclosure.

In one aspect of the present disclosure, there is provided a battery module including a cell stack including a plurality of battery cells; and a housing including a base plate covering a lower surface of the cell stack, a cover plate covering an upper surface of the cell stack, and a connector connecting the base plate and the cover plate, and accommodating the cell stack, wherein the base plate and the cover plate have a curved shape so that the central region thereof is located closer to the cell stack than the edge regions.

The cell stack may further include a pair of swelling absorbing pads disposed at both outermost sides of the cell stack in a stacking direction.

Each of the pair of swelling absorbing pads may have a shape in which the thickness of the central region is smaller than the thickness of the edge regions.

Each of the pair of swelling absorbing pads may have a stepped shape so that a height of the surfaces facing the base plate and the cover plate become lower in a direction from the edge regions toward the central region.

Each of the pair of swelling absorbing pads may have a curved shape so that the surfaces facing the base plate and the cover plate are in full contact with the base plate and the cover plate.

The connector may include an elongation portion having a relatively higher elongation than the peripheral region.

The elongation portion may correspond to a region made of a metal having a relatively low elongation compared to the peripheral region.

The elongation portion may correspond to a region formed to be thinner than the peripheral region.

Meanwhile, in another aspect of the present disclosure, there is provided a battery pack including a battery module according to an embodiment of the present disclosure.

In another aspect of the present disclosure, there is provided a vehicle including a battery pack according to an embodiment of the present disclosure.

According to an aspect of the present disclosure, it is possible to resolve deviation of the pressure applied to a battery cell due to swelling, and to improve the bending rigidity of the housing at a position corresponding to the central region of the battery cells.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus the present disclosure is not construed as being limited to the drawings.

FIG. 1 is an illustration of a conventional battery module.

FIGS. 2 to 5 are illustrations of a battery module according to an embodiment of the present disclosure.

FIGS. 6 and 7 are illustrations showing the deformation in the housing due to swelling in a battery module according to an embodiment of the present disclosure.

FIGS. 8 and 9 are illustrations of various shapes of a swelling absorbing pad in a battery module according to an embodiment of the present disclosure.

FIGS. 10 to 12 are illustrations of a battery module according to another embodiment of the present disclosure.

FIGS. 13 and 14 are illustrations of a battery module according to still another embodiment of the present disclosure.

FIG. 15 is an illustration of a battery pack according to an embodiment of the present disclosure.

FIG. 16 is an illustration of a vehicle according to an embodiment of the present disclosure.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferred example for the purpose of illustrations only, not intended to limit the scope of the disclosure, so it should be understood that other equivalents and modifications could be made thereto without departing from the scope of the disclosure.

A battery module 1 according to an embodiment of the present disclosure will be described with reference to FIGS. 2 to 7. As illustrated in FIGS. 2 to 7, the battery module 1 according to an embodiment of the present disclosure includes a cell stack 10 and a housing 20.

The cell stack 10 includes a plurality of battery cells 11. As the battery cells 11, for example, pouch-type battery cells may be used. Each of the battery cells 11 includes a pair of electrode leads 11a extending to the outside of the battery cell 11 in a longitudinal direction (direction parallel to the X-axis) of the battery cell 11. The pair of electrode leads 11a may be drawn out in the same direction or in opposite directions. The plurality of battery cells 11 are stacked to face each other in a vertical direction (direction parallel to the Z-axis).

The cell stack 10 may further include a pair of swelling absorbing pads 12 disposed at both outermost sides of the cell stack 10 in a stacking direction (direction parallel to the Z-axis). Swelling absorbing pads 12 may be disposed between the battery cells 11 adjacent to each other in addition to both outermost sides of the cell stack 10 in a stacking direction. The swelling absorbing pads 12 may be compressed when the battery cells 11 undergo swelling due to repeated charge/discharge cycles, thereby absorbing volume expansion of the battery cells 11.

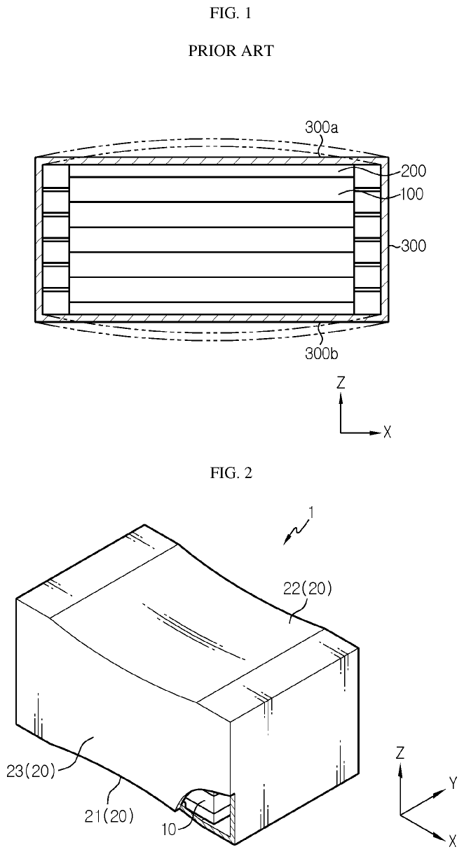

Each of the swelling absorbing pads 12 may have a flat shape like the swelling absorbing pad 200 provided in the conventional battery module shown in FIG. 1, but may have a shape corresponding to a housing 20 having a curved shape as described below. The specific shape of the swelling absorbing pad 12 will be described later in detail after the description of the housing 20 of the present disclosure.

The housing 20 includes a base plate 21, a cover plate 22, and a connector 23. The housing 20 accommodates the cell stack 10 therein. The housing 20 may be made of a metal material to ensure rigidity.

The base plate 21 covers a lower surface (surface parallel to the X-Y plane) of the cell stack 10. The cover plate 22 covers an upper surface (surface parallel to the X-Y plane) of the cell stack 10. The connector 23 connects the base plate 21 and the cover plate 22.

The connector 23 may be integrally formed with the base plate 21 and/or the cover plate 22. On the other hand, the connector 23 may be formed separately from the base plate 21 and/or the cover plate 22 and may be fastened to the base plate 21 and/or the cover plate 22 by welding, bolting, or the like.

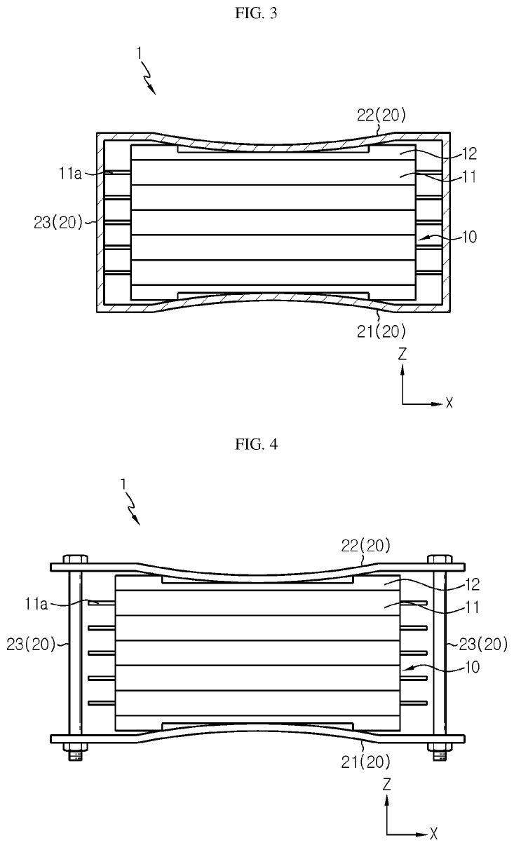

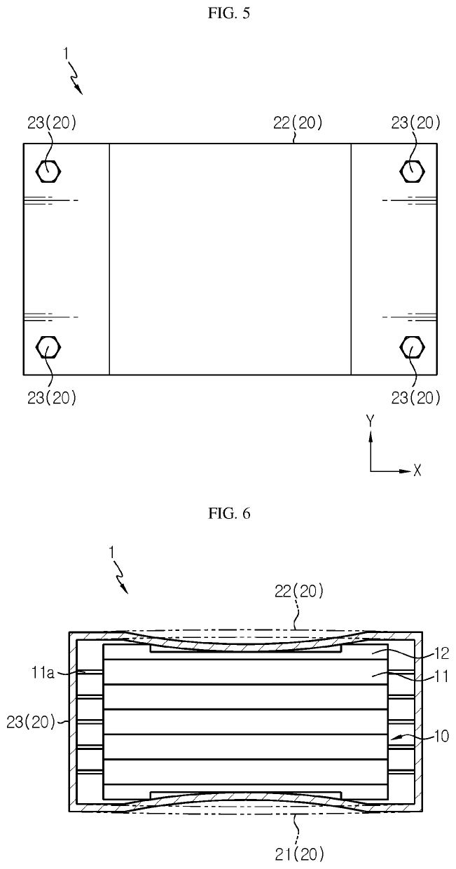

As illustrated in FIGS. 2 and 3, the connector 23 may have a shape including side plates forming a side surface of the module housing 20. On the other hand, as illustrated in FIGS. 4 and 5, the connector 23 may have a bar or beam shape for connecting and fixing the base plate 21 and the cover plate 22. The connector 23 may be fastened to four corner regions of each of the base plate 21 and the cover plate 22.

The base plate 21 and the cover plate 22 have a curved shape so that the central region thereof is located closer to the cell stack 10 than the edge regions. In the drawings of the present disclosure, there is shown only the case in which the swelling absorbing pad 12 is interposed between the base plate 21 and the battery stack 10 and between the cover plate 22 and the battery stack 10, respectively. However, the present disclosure is not limited thereto, but also includes the case in which the swelling absorbing pad 12 is excluded.

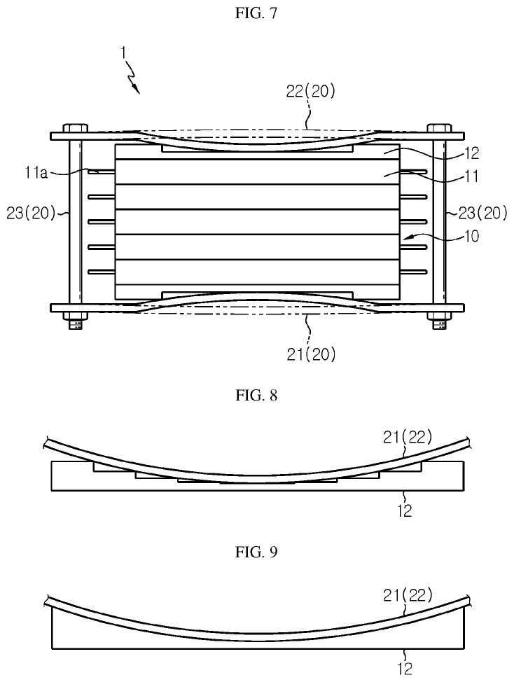

As illustrated in FIGS. 6 and 7, when the battery cells 11 swell, the central region of the battery cells 11 come into contact with the base plate 21 and the cover plate 22 prior to the edge regions thereof due to the curved shape of the base plate 21 and the cover plate 22. Therefore, the central region of the battery cells 11 are pressurized first until the volume expansion of the battery cells 11 occurs at a predetermined level or more due to swelling. When the volume expansion of the battery cells 11 is at a predetermined level or more due to swelling, the edge regions of the battery cell 11 also come into contact with the base plate 21 and the cover plate 22, thereby allowing pressure to be applied over the entire area of the battery cells 11.

Meanwhile, when the battery module 1 according to an embodiment of the present disclosure includes a pair of swelling absorbing pads 12 located at both outermost sides of the cell stack 10 in a stacking direction, each of the pair of swelling absorbing pads 12 may have a shape in which the thickness of the central region thereof is smaller than the thickness of the edge regions thereof. In this case, the contact area between the cell stack 10 and the base plate 21 and the contact area between the cell stack 10 and the cover plate 22 may be increased. Therefore, when the volume expansion occurs due to swelling of the battery cell 11, uniform pressure may be applied over the entire area of the battery cells 11.

As illustrated in FIGS. 2 to 8, each of the pair of swelling absorbing pads 12 may have a stepped shape so that a surface facing the base plate 21 and the cover plate 22 is gradually lowered from the edge regions toward the central region. In a stepped shape formed on the swelling absorbing pad 12, one stepped structure may be provided as shown in FIGS. 2 to 7, or a plurality of stepped structures may be provided as shown in FIG. 8.

As shown in FIG. 9, each of the pair of swelling absorbing pads 12 has a curved shape in which a surface facing the base plate 21 and the cover plate 22 is in full contact with the base plate 21 and the cover plate 22, unlike those shown in FIGS. 2 to 8.

As described above, the battery module 1 according to an embodiment of the present disclosure includes the base plate 21 and the cover plate 22 having a curved shape, and optionally includes swelling absorbing pads 12 having a shape corresponding to the base plate 21 and the cover plate 22, thereby allowing uniform pressure to be applied over the entire area of the battery cells 11 when swelling occurs.

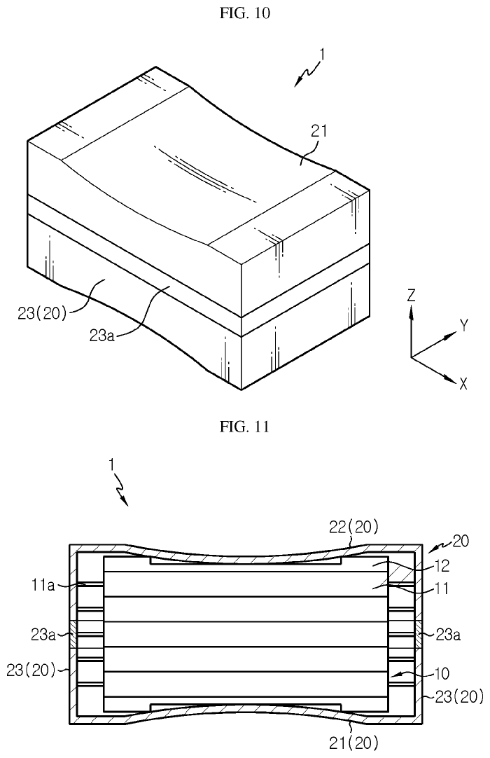

Next, the battery module 1 according to another embodiment of the present disclosure will be described with reference to FIGS. 10 to 14. The battery module 1 according to another embodiment of the present disclosure may include the same characteristics as the battery module 1 according to the previous embodiment, except that the elongation portion 23a is provided in the connector 23 as compared with the battery module 1 according to the previous embodiment. Therefore, in describing the battery module 1 according to another embodiment of the present disclosure, the connector 23 may be intensively described, and any descriptions overlapping with the previous embodiment may be omitted.

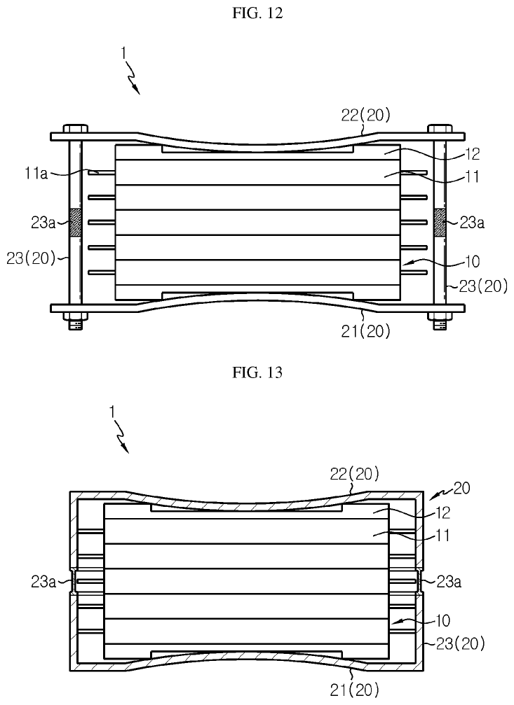

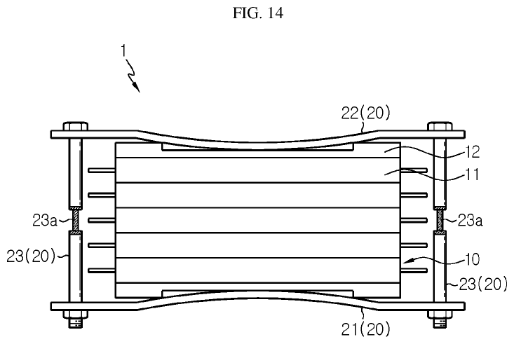

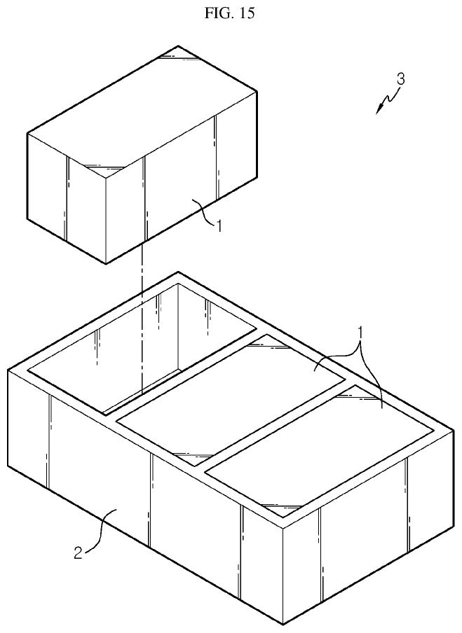

As illustrated in FIGS. 10 to 14, the connector 23 includes an elongation portion 23a having a relatively higher elongation than the peripheral region. As illustrated in FIGS. 10 to 12, the elongation portion 23a may correspond to a region made of a metal having a relatively higher elongation than the peripheral region. On the other hand, as shown in FIGS. 13 and 14, the elongation portion 23a may correspond to a region formed to be thinner than the peripheral region.

The elongation portion 23a may be finely extended when a tensile force exceeding a predetermined level is applied to the connector 23 as the base plate 21 is subjected to a downward force and the cover plate 22 is subjected to an upward force due to the pressure caused by swelling. Due to the elongation of the elongation portion 23a, it is possible to prevent the pressure applied to the battery cells 11 from being excessively increased. The metal material constituting the elongation portion 23a and/or the thickness of the elongation portion 23a may be appropriately selected in consideration of the magnitude of pressure according to swelling of the battery cells 11.

As described above, the battery module 1 according to another embodiment of the present disclosure may have a structure in which the connector 23 may be finely extended when a tensile force exceeding a predetermined level is applied, in addition to a structure in which the pressure due to swelling may be uniformly applied over the entire area of each of the battery cells 11. Therefore, in the battery module 1 according to another embodiment of the present disclosure, it is possible to prevent damage to the battery cells 11 due to excessively large pressure applied to the battery cells 11.

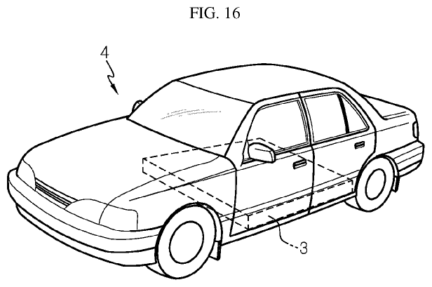

As illustrated in FIG. 15, a battery pack 3 according to an embodiment of the present disclosure includes at least one battery module 1 according to the present disclosure. The battery pack 3 may have a shape in which the battery module 1 is accommodated in the pack housing 2.

Meanwhile, as illustrated in FIG. 16, a vehicle 4 according to an embodiment of the present disclosure includes the battery pack 3 according to an embodiment of the present disclosure as described above. The vehicle 4 may be, for example, an electric vehicle operated by the power from the battery pack 3.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

1. A battery module comprising:
a cell stack comprising a plurality of battery cells; and
a housing comprising a base plate covering a lower surface of the cell stack, a cover plate covering an upper surface of the cell stack, and a connector connecting the base plate and the cover plate,
wherein the housing accommodates the cell stack,
wherein each of the base plate and the cover plate has a curved shape such that a central region of the base plate and the cover plate, respectively, is located closer to the cell stack than edge regions of the respective base plate and the cover plate,
wherein the cell stack further comprises a pair of swelling absorbing pads,
wherein each of the pair of swelling absorbing pads is disposed at a respective outermost side of the cell stack in a stacking direction, and
wherein each of the pair of swelling absorbing pads has a shape in which a thickness of a central region of the swelling absorbing pad is smaller than a thickness of edge regions of the swelling absorbing pad.

2. The battery module according to claim 1,
wherein each of the pair of swelling absorbing pads has a stepped shape such that surfaces of the swelling absorbing pads facing the base plate and the cover plate, respectively, become lower in a direction from edge regions of the swelling absorbing pads toward a central region of the swelling absorbing pads.

3. The battery module according to claim 1,
wherein each of the pair of swelling absorbing pads has a curved shape such that surfaces of the swelling absorbing pads facing the base plate and the cover plate, respectively, are in continuous surface contact with the base plate and the cover plate.

4. The battery module according to claim 1,
wherein the connector comprises an elongation portion having a higher elongation than a peripheral region of the connector.

5. The battery module according to claim 4,
wherein the elongation portion corresponds to a region comprising a metal material having a higher elongation than the peripheral region of the connector.

6. The battery module according to claim 4,
wherein the elongation portion corresponds to a region having a thickness that is smaller than a thickness of the peripheral region.

7. A battery pack comprising a battery module according to claim 1.

8. A vehicle comprising the battery pack according to claim 7.
